(19) United States
(12) Patent Application Publication
(10) Pub. No.: US 2009/0077133 A1
(43) Pub. Date: Mar. 19, 2009

(54) SYSTEM AND METHOD FOR EFFICIENT RULE UPDATES IN POLICY BASED DATA MANAGEMENT

(76) Inventors: Windsor Hsu, San Jose, CA (US); Lan Huang, Sunnyvale, CA (US)

Correspondence Address: LEWIS NUNNELLEY, Post Office 2428, Corvallis, OR, 97339, US

(21) Appl. No.: 11/856,475

(22) Filed: Sep. 17, 2007

(51) Int. Cl. G06F 17/30

(52) U.S. Cl. 707/200; 707/E17.005

(57) ABSTRACT

A method, system, and computer program product is provided for efficient policy rule update in a data management system. A policy rule is stored along with the attributes of a data object when the application of the policy rule results in action taken on the data object. A stored policy rule, called an effective policy rule, is subsequently used to restrict the number of data objects examined when a policy rule is added, deleted, modified, or otherwise updated.

### BACKGROUND OF THE INVENTION

1. Technical Field

The invention relates to a system and method for providing efficient policy rule updates in policy based data management. More particularly, the invention relates to a system and method for restraining the size of the set of data objects to be examined after a policy rule update.

2. Background of the Invention

Many data objects such as business records, weather data, security information, and the like are now stored on digital media. Users of storage systems may have millions or even billions of data objects to manage. Manually managing such large numbers of data objects is not practical. Policy based data management automates tasks to a great extent and is essential for a system containing large numbers of data objects.

In a typical system with large numbers of data objects, policy rules are used to facilitate the management tasks. A typical policy rule includes scope, priority, condition, and action. Scope defines the domain that a rule will cover. Rules with different scopes will handle orthogonal actions and do not interfere with each other. A rule with a smaller priority number carries higher priority and overwrites lower priority rules. The action is taken on a data object if the condition is matched. To determine if the condition attribute of a data object matches the condition requirement of a rule, a calculation is performed to compare the scope and condition of the policy rule with the corresponding attributes of the data object. Large data management systems commonly include an attribute server and an attribute indexer. Data objects have attributes such as confidentiality level, age, and the like. These attributes are maintained by the attribute server. The attribute indexer maintains the indices for the data object attributes and facilitates any query process on the attributes.

Policy rules are applied to data objects to perform management functions. Table 1 gives three illustrative examples of policy rules. The system will use rule 1 to search for data objects having the condition of creation time older than one year. When those data objects are found, the action taken is deletion of the found data objects. In order to find the data objects in this example, a computation is made comparing the condition of rule 1 with the attributes of each data object to determine if the creation time is older than one year. Typically, a computation must be made for each of the very large number of data objects. Thus, computing even one policy rule against every data object requires considerable system resources and can have a very large impact on system performance and system throughput.

TABLE 1
Illustrative examples of policy rules.

| Rule | Scope | Priority | Condition | Action |
|---|---|---|---|---|
| 1 | Expiration | 1 | Creation time | Deletion |
| | | | older than one | |
| | | | year | |
| 2 | Confidentiality | 1 | Suffix is | Assign |
| | | | “password” | confidential |
| | | | | level 5 |
| 3 | Confidentiality | 2 | Owner is Jack | Assign |
| | | | | confidential |
| | | | | level 4 |

One feature of data objects is that attributes (such as content category, file size, ownership, retention, etc.) of the objects change over time. The policy rules also may change over time. The policy rules may be deleted, added, altered, modified, or otherwise updated depending on either system or user requirements. Typically, policy rules are applied to all the objects in the system from the highest priority to the lowest priority. In Table 1, for example, rule 2 with a scope of “confidentiality” and a priority of 1 is applied to all the data objects. Then rule 3 also with a scope of “confidentiality” but with a priority of 2 is applied to all the data objects. However, a rule of lower priority is not allowed to alter the action of a rule with higher priority. In the example from Table 1, rule 3 is not allowed to overwrite the actions taken by rule 2. In general, if any of the policy rules are updated (deleted, added, altered, or modified) then a cycle of computations is launched comparing the rules to the appropriate attributes of each one of the data objects.

The overhead of computing each rule against each data object in a typical data management system is a very expensive use of system resources. Such computations have a deleterious impact on system throughput and system performance. What is needed is a method and system wherein the number of data objects to be included in the policy rule calculations can be constrained to a smaller set thereby resulting in greater system efficiency.

### SUMMARY OF THE INVENTION

In one embodiment, the invention provides for the creation of an effective policy rule. In addition, an embodiment of the invention provides for a method of restricting the number of data objects to be examined when a policy rule is updated. In one embodiment, the condition of a policy rule is calculated against the attributes of a data object to determine if the condition of the data object is a match for the specified policy rule condition. If the conditions are met then action is taken on the data object and the policy rule is stored along with the attributes of the data object. The stored policy rule, called herein an effective policy rule, is then used to restrict the number of data objects to be examined when a policy rule update is made. In one embodiment, when a new policy rule is introduced, the set of data objects is identified that have an effective priority less than the priority of the new policy rule. The new policy rule is then calculated against each data object in the set of data objects. In another embodiment, when a policy rule is deleted, the set of data objects are found having the policy rule to be deleted as an effective rule. The remaining policy rules with a priority less than the priority of the deleted rule is calculated against each of the data objects in the set of data objects. In another embodiment, when a policy rule is updated, there is a two step method of first deleting the original policy rule, then adding the updated policy rule. In all of these embodiments, a restricted set of data objects are involved in the application of policy rules resulting in improved system performance and throughput.

### BRIEF DESCRIPTION OF THE DRAWINGS

Referring now to the drawings which are intended to be illustrative of typical embodiments of the invention and are not considered to limit the scope of the invention nor to exclude other equally effective embodiments:

FIG. 1 illustrates details of the creation of an effective policy rule;

FIG. 2 illustrates details of an initialization method of the present invention;

FIG. 3 illustrates a method for deleting a priority rule according to the present invention;

FIG. 4 illustrates a method for inserting a priority rule according to the present invention;

FIG. 5 illustrates a method for updating a priority rule according to the present invention; and,

FIG. 6 illustrates an exemplary computer system in accordance with one embodiment of the invention.

### DETAILED DESCRIPTION OF THE INVENTION

The present invention provides a method and system for restraining the number of data objects which must be inspected when either a data object is altered or a policy rule is deleted, added, altered, modified, or otherwise updated. By constraining the set of data objects to be inspected, the number of computations is limited and the system is more efficient.

In certain embodiments of the invention, a policy rule is stored along with the attributes of a data object when the conditions of the policy rule match that of the data object and an action is taken. In certain embodiments of the invention, only the identifier of the policy rule is stored. A policy rule thus stored with the data object is herein called an effective policy rule. If the identifier of the policy rule is stored, then the stored identifier is also called an effective policy rule. Either storing the policy rule or storing the identifier of the policy rule results in an effective policy rule. The priority of the policy rule thus stored is herein called an effective priority. Minimal space is required to store effective policy rules. In one embodiment, the effective rule and the effective priority are stored as additional fields along with other attributes of the data objects in a database table. The information for policy rules stored with each data object is conveniently indexed and queried through known methods and techniques such as using structured query language (SQL) or the like. Using a query language such as SQL is much less consumptive of system resources than performing the calculations of policy rules against data objects. The results from a query language search of the effective policy rule information is used to significantly constrain the number of data objects to be calculated against a policy rule.

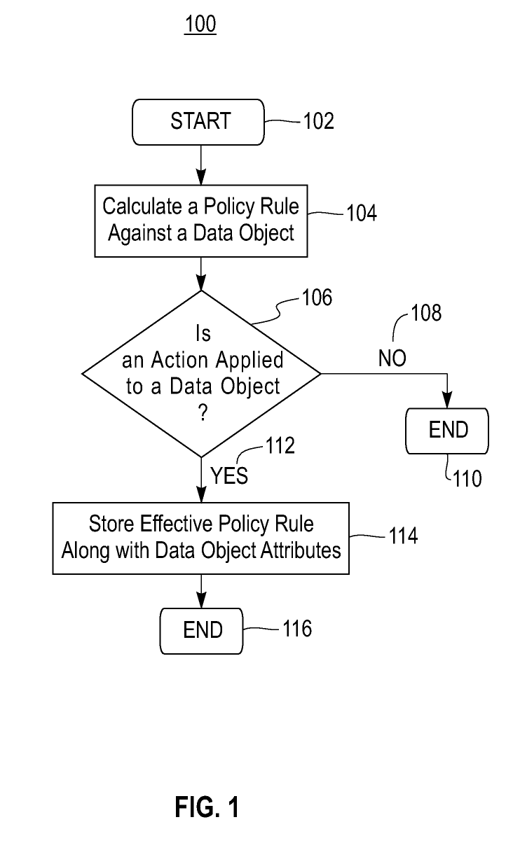

FIG. 1 illustrates one embodiment 100 of a method for creating an effective policy rule. In block 102 the method starts. In block 104 a policy rule is calculated against a data object. The meaning of “calculated against” is to perform the calculation comparing the scope and condition of the policy rule with the corresponding attributes of the data object. If the condition of the policy rule matches the condition of the data object, then the indicated action is applied. In block 106 a query is made as to whether an action has been applied to the data object. If the action has been applied 112 then the policy rule, or alternatively the identifier of the policy rule, is stored as an effective policy rule 114 along with the data object attributes. The method 100 then ends 116. If no action was taken 108 then the method ends 110.

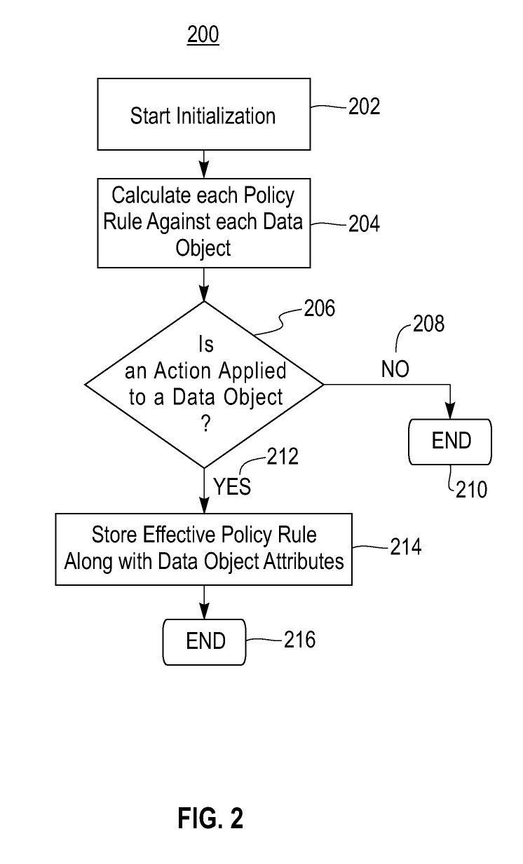

When first using the invention in a policy based data management system, it is preferable to initialize the system. One embodiment 200 of an initialization is illustrated in FIG. 2. In block 202 the initialization starts. In block 204 each policy rule is calculated against each data object. If 206 a data object has conditions which match 212 the condition part of the policy rule, then the action is applied to that data object. The policy rule then becomes an effective rule and is stored 214 along with the data object or along with the attributes of the data object. If a data object does not 210 have conditions which match the condition part of the policy rule, then no action is applied and the policy rule is not an effective rule for that data object. After calculation of each policy rule against each data object the initialization ends with no action taken 110 or ends with action taken and an effective policy rule created 216.

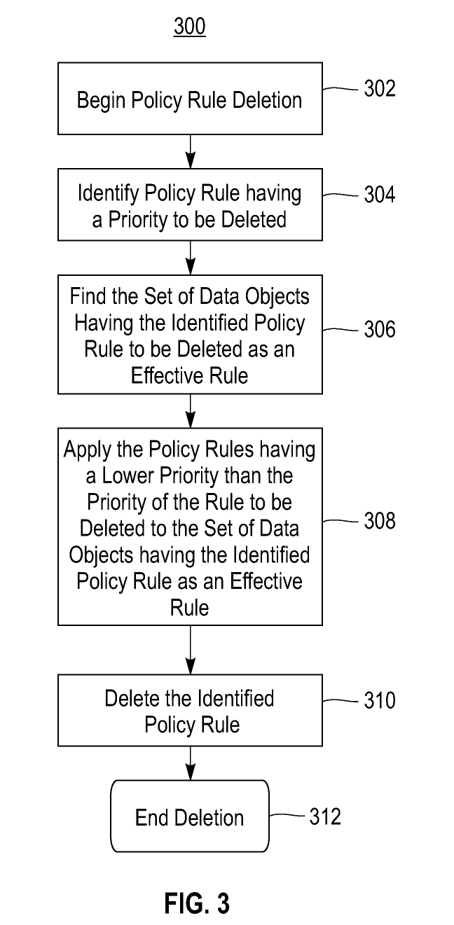

When a policy rule is deleted, the actions from lower priority policy rules will be allowed. In FIG. 3 an embodiment 300 of the present invention is illustrated when deleting a policy rule. Block 302 is the beginning. In block 304 a policy rule having a priority is identified for deletion. In block 306 the set of data objects is found having the identified policy rule as an effective rule. In block 308 the policy rules having a lower priority than the priority of the policy rule to be deleted are applied to the set of data objects having the identified policy rule as an effective rule. In block 310 the identified policy rule is deleted. In block 312 policy rule deletion ends.

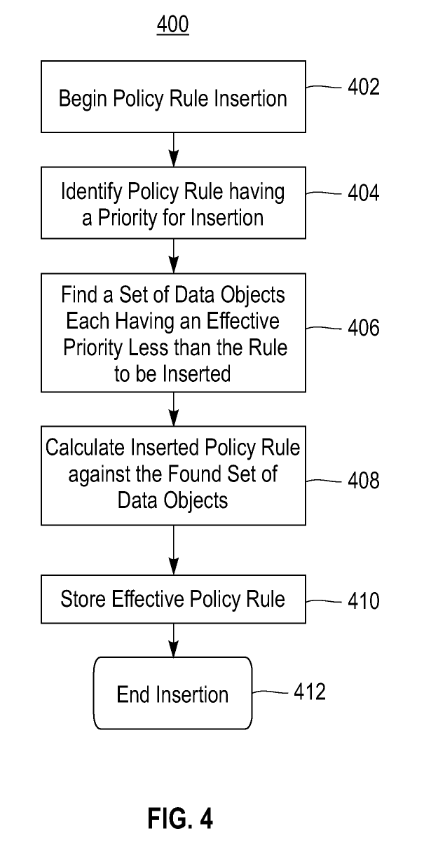

FIG. 4 illustrates an embodiment of the invention during policy rule insertion into a group of existing rules. Block 402 is the beginning. In block 404 a policy rule having a priority is identified for insertion. In block 406 a set of data objects is found where each data object in the set has an effective priority less than the priority of the policy rule to be inserted. In block 408 the inserted policy rule is applied to the found set of data objects. In block 410 when conditions are matched between a data object and the inserted policy rule, action is taken and the inserted policy rule becomes an effective policy rule for that data object. The effective policy rules are stored accordingly 410. In block 412 insertion ends.

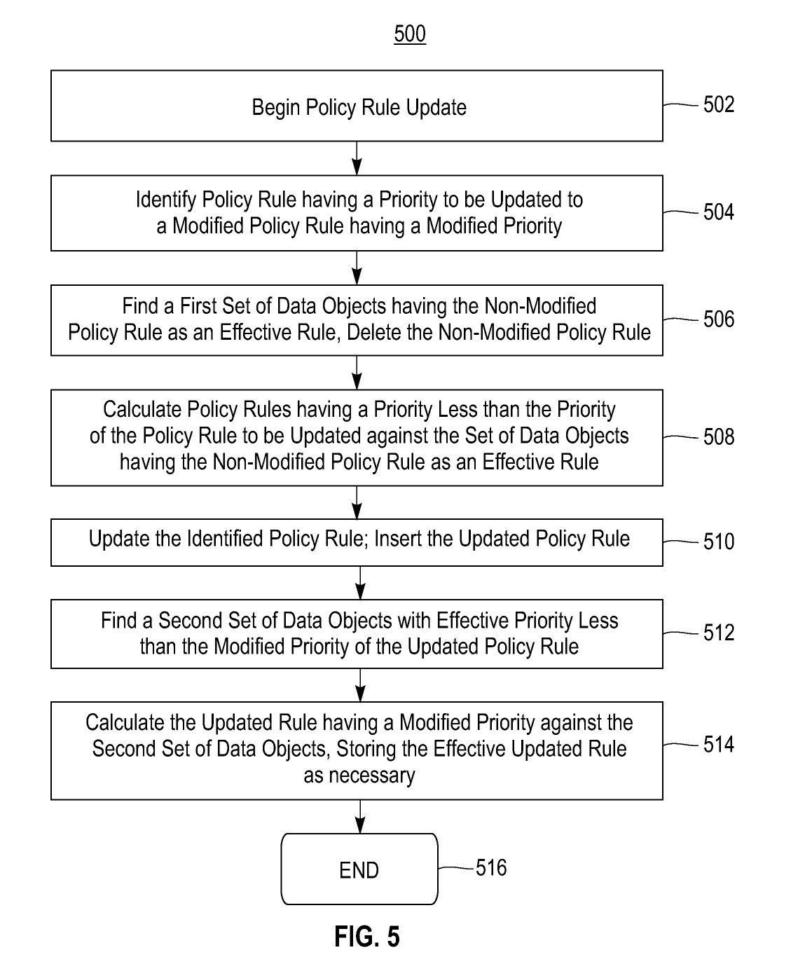

In FIG. 5 an embodiment 500 of the present invention is illustrated when a policy rule is updated. First the original policy rule is deleted, and then the updated policy rule is added. Block 502 is the beginning. In block 504 a policy rule having a priority is identified to be updated to a modified policy rule having a modified priority. In block 506 the set of data objects having the original, non-updated policy rule as an effective rule is found. In block 508 policy rules having a priority less than the priority of the policy rule to be updated are applied to the set of data objects having the non-updated rule as an effective rule. In block 510 the identified priority rule is updated. In block 512 a second set of data objects is found having priority rules with effective priority less than the updated priority of the updated rule. In block 514 the updated policy rule having an updated priority is then applied to the second set of data objects. During the calculations in block 514 if action is taken, the updated policy rule becomes an effective rule and is stored accordingly. In block 516 updating ends. The example illustrated in FIG. 5 has a policy rule that is modified in priority and in another attribute such as scope or condition. However, this illustration is equally valid when either the priority or another attribute is updated.

In each of the examples discussed above for policy rule deletion, addition, and update, the set of data objects to be calculated against is less than the total number of data objects. Thus in these examples, the embodiments of the invention result in greater efficiency.

The described embodiments of the invention may be implemented as a method, computer program product, apparatus, or system using standard programming and related engineering techniques to produce software, firmware, hardware, and any combination of these. Each of the embodiments may take the form of an entirely hardware embodiment, an entirely software embodiment or an embodiment contain both hardware and software elements. The embodiments may be implemented in software, which includes but is not limited to firmware, resident software, microcode, and the like.

The embodiments of the present invention may take the form of a computer program product accessible form a computer-usable or computer-readable medium providing program code for use by or in connection with a computer or any instruction execution system. For the purposes of this description, a computer-usable or computer-readable medium may be any apparatus that may contain, store, communicate, propagate, or transport the program for use by or in connection with the execution system, apparatus, or device.

The described operations may be implemented as code maintained in a computer-usable or computer-readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a magnetic disk drive, a removable disk, an optical disk, volatile and non-volatile memory devices, and the like.

The code implementing the desired operations may further be implemented in hardware logic such as an integrated chip, or programmable array, or the like. Additionally, the code implementing the described operations may be implemented in transmission signals, where transmission signals may propagate through space or through a transmission medium such as an optical fiber, copper wire, and the like. The transmission signals in which the code or logic is encoded may further comprise a wireless signal (local or long distance), satellite transmission, and the like. The transmission signals in which the code or logic in encoded is capable of being transmitted by a transmitting station and received by a receiving station, where the code or logic encoded in the transmission signal may be decoded and stored in hardware or a computer readable medium at the receiving and transmitting stations or devices. Logic, as used here, may include software, hardware, firmware, or any combination thereof. Those skilled in the art will recognize that many modifications may be made to these configurations without departing from the scope of the embodiments, and that the computer product may comprise any suitable information bearing medium known in the art.

The embodiments described in detail above are illustrative examples and illustrate specific operations occurring in a particular order. In alternative embodiments, certain of the logic operations may be performed an alternate order, modified, or be removed and remain within the scope of the invention. Further, certain operations described herein may occur sequentially or certain operations may be processed in parallel. Certain operations may also be implemented as a single process or as distributed processes.

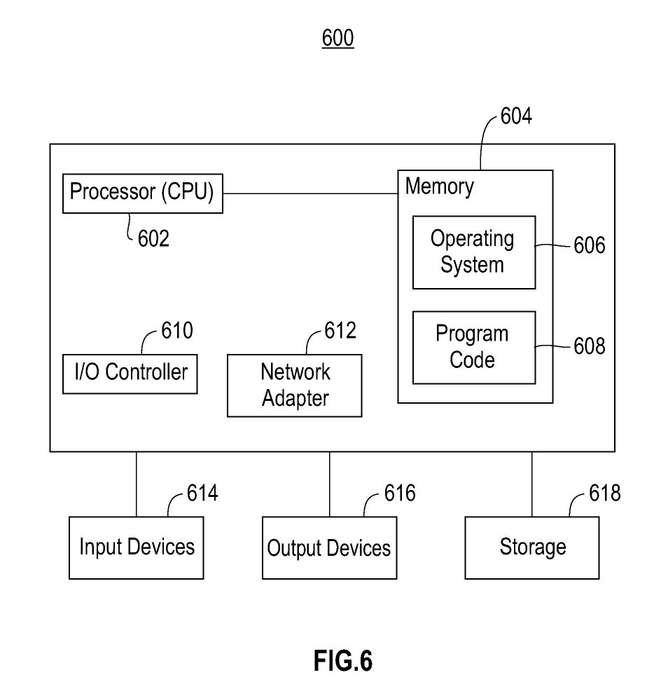

FIG. 6 illustrates a computer system used to implement certain embodiments of the present invention. The system 600 includes at least one processor 602 for executing code which may be stored in memory 604 or externally 618 in accordance with an operating system 606. Input 614 and output 616 (I/O) devices (including but not limited to workstations, monitors, keyboards, and the like) are coupled with the system either directly or through intermediate I/O controllers 610. Network adaptors 612 are also commonly coupled to the system to facilitate communication with remote devices or networks. Storage devices 618 are also commonly coupled to the system for storing program and user data. Those skilled in the art will recognize many different configurations of a computer system differing from that illustrated here that could also be efficacious in implementing the embodiments of the present invention without leaving the scope of the invention.

We claim:

1. A method for an efficient policy rule update in policy based data management having policy rules, comprising:
calculating a policy rule against a data object having attributes; and
storing an effective policy rule along with the attributes of the data object if an action was taken on the data object.

2. The method of claim 1, wherein when a new policy rule is inserted into existing policy rules, the method further comprises:
inserting a new policy rule having a priority into the existing policy rules;
identifying a set of data objects each of which has an effective policy rule wherein the effective priority is less than the priority of the new policy rule; and,
calculating said new policy rule against each data object in said set of data objects.

3. The method of claim 1, wherein when a policy rule is deleted, the method further comprises:
identifying a policy rule to be deleted, said policy rule having a priority;
finding a set of data objects each of which has said policy rule to be deleted as an effective policy rule;
deleting said policy rule; and,
calculating remaining policy rules each having a priority less than the priority of said deleted policy rule against each of data objects in said set of data objects.

4. The method of claim 1, wherein when a policy rule is updated, the method further comprises:
identifying a policy rule having a priority to be updated to a modified policy rule having a modified priority;
finding a first set of data objects having said policy rule as an effective policy rule;
deleting said policy rule;
calculating policy rules having a priority less than the priority of said policy rule to be updated against said first set of data objects;
updating said policy rule;
inserting said policy rule;
finding a second set of data objects having effective policy rules with effective priority less than the modified priority of said updated policy rule; and,
calculating said updated policy rule against each of said second set of data objects.

5. A computer program product comprising a computer useable medium including a computer readable program, wherein the computer readable program when executed on a computer causes the computer to:
calculate a policy rule against a data object having attributes; and
store effective policy rule along with the attributes of the data object if an action was taken on the data object.

6. The computer program product of claim 5, wherein the computer program product when executed on a computer causes the computer to:
insert a new policy rule having a priority into existing rules;
identify a set of data objects each of which has an effective policy rule wherein the effective priority is less than the priority of the new policy rule; and,
calculate said new policy rule against each data object in said set of data objects.

7. The computer program product of claim 5, wherein the computer program product when executed on a computer causes the computer to:
identify a policy rule to be deleted, said policy rule having a priority;
find a set of data objects each of which has said policy rule to be deleted as an effective policy rule;
delete said policy rule; and,
calculate remaining policy rules each having a priority less than the priority of said
deleted policy rule against each of data objects in said set of data objects.

8. The computer program product of claim 5, wherein the computer program product when executed on a computer causes the computer to:
identify a policy rule having a priority to be updated to a modified policy rule having a modified priority;
find a first set of data objects having said policy rule as an effective policy rule;
delete said policy rule;
calculate policy rules having a priority less than the priority of said policy rule to be updated against said first set of data objects;
update said policy rule;
insert said policy rule;
find a second set of data objects having effective policy rules with effective priority less than the modified priority of said updated policy rule; and,
calculate said updated policy rule against each of said second set of data objects.

9. A system, comprising logic capable of performing operations, the operations comprising:
calculating a policy rule against a data object having attributes; and
storing effective policy rule along with the attributes of the data object if an action was taken on the data object.

10. The system of claim 9, wherein the operations further comprise:
inserting a new policy rule having a priority into existing rules;
identifying a set of data objects each of which has an effective policy rule wherein the effective priority is less than the priority of the new policy rule; and,
calculating said new policy rule against each data object in said set of data objects.

11. The system of claim 9, wherein the operations further comprise:
identifying a policy rule to be deleted, said policy rule having a priority;
finding a set of data objects each of which had said policy rule to be deleted as an effective policy rule;
deleting said policy rule; and,
calculating remaining policy rules each having a priority less than the priority of said deleted policy rule against each of data objects in said set of data objects.

12. The system of claim 9, wherein the operations further comprise:
identifying a policy rule having a priority to be updated to a modified policy rule having a modified priority;
finding a first set of data objects having said policy rule as an effective policy rule;
deleting said policy rule;
calculating policy rules having a priority less than the priority of said policy rule to be updated against said first set of data objects;
updating said policy rule;
inserting said policy rule;
finding a second set of data objects having effective policy rules with effective priority less than the modified priority of said updated policy rule; and,
calculating said updated policy rule against each of said second set of data objects.

13. A method for initializing a storage system having data objects and a policy based data management system including policy rules, comprising:
calculating each policy rule in the policy based data management system against each data object having attributes; and,
for each data object, storing an effective policy rule along with the attributes of said each data object if an action was taken on each said data object.
